(19) United States
(12) Patent Application Publication
(10) Pub. No.: US 2013/0027171 A1
(43) Pub. Date: Jan. 31, 2013

(54) ELECTRONIC COMPONENT AND MANUFACTURING METHOD FOR SAME

(71) Applicant: MURATA MANUFACTURING CO., LTD., Kyoto (JP)

(72) Inventor: Yoichiro ITO, Nagaokakyo-shi (JP)

(73) Assignee: MURATA MANUFACTURING CO., LTD., Kyoto (JP)

(21) Appl. No.: 13/631,107

(22) Filed: Sep. 28, 2012

Related U.S. Application Data
(63) Continuation of application No. PCT/JP2010/068280, filed on Oct. 18, 2010.

(30) Foreign Application Priority Data
Mar. 31, 2010 (JP) 2010-082720

(51) Int. Cl. H01F 5/00; H01F 41/04

(52) U.S. Cl. 336/200; 156/182

(57) ABSTRACT

An electronic component and manufacturing method for preparing an electronic component includes providing a first insulator layer having a first nickel content rate. A coil conductor and a second insulator layer having a first bismuth content rate and a second nickel content rate higher than the first nickel content rate are provided on the first insulator layer. The first insulator layer, the coil conductor, and the second insulator layer constitute a first unit layer. The first unit layer and an exterior insulator layer are laminated to obtain a laminate. After a step of firing the laminate, a nickel content rate in a first portion of the first insulator layer, the first portion being sandwiched between the coil conductors from both sides facing in a lamination direction, is lower than a nickel content rate in a second portion of the first insulator layer other than the first portion.

### CROSS REFERENCE TO RELATED APPLICATIONS

The present application claims priority to International Application No. PCT/JP2010/068280 filed on Oct. 18, 2010, and to Japanese Patent Application No. 2010-082720 filed on Mar. 31, 2010, the entire contents of each of these applications being incorporated herein by reference in their entirety.

### TECHNICAL FIELD

The technical field relates to an electronic component and a manufacturing method for the electronic component, and more particularly to an electronic component with a coil incorporated therein, and a manufacturing method for the electronic component.

### BACKGROUND

As a conventional electronic component, there is known a multilayer coil component of open magnetic path type, which is described in Japanese Unexamined Patent Application Publication No. 2005-259774 (Patent Literature 1). FIG. 9 is a sectional structural view of a multilayer coil component 500 of open magnetic path type, which is described in Patent Literature 1.

The multilayer coil component 500 of open magnetic path type includes, as illustrated in FIG. 9, a laminate 502 and a coil L. The laminate 502 is made up of a plurality of magnetic layers laminated one above another. The coil L has a helical shape and is made up of a plurality of coil conductors 506 connected in series. Further, the multilayer coil component 500 of open magnetic path type includes a non-magnetic layer 504. The non-magnetic layer 504 is disposed in the laminate 502, and it extends across the coil L.

In the multilayer coil component 500 of open magnetic path type, a magnetic flux φ 510 circling around the coil L passes through the non-magnetic layer 504. This suppresses the occurrence of magnetic saturation due to excessive concentration of the magnetic flux within the laminate 502. As a result, the multilayer coil component 500 of open magnetic path type exhibits good direct-current superposition characteristics.

### SUMMARY

The present disclosure provides an electronic component capable of suppressing the occurrence of magnetic saturation due to magnetic fluxes circling around individual coil conductors, and a manufacturing method for the electronic component.

In one aspect of the disclosure, a manufacturing method for an electronic component includes a step of forming a laminate that incorporates a helical coil made up of a plurality of coil conductors, and a step of firing the laminate. The step of forming the laminate includes a step of forming a first unit layer through a process of preparing a first insulator layer having a first Ni content rate, a process of forming the coil conductor, which constitutes the helical coil, on the first insulator layer, and a process of forming a second insulator layer on a portion of the first insulator layer other than the coil conductor, the second insulator layer having a first Bi content rate and a second Ni content rate higher than the first Ni content rate, and a step of laminating the first unit layer in plural.

In a more specific embodiment, the step of forming the laminate may further include a step of forming a second unit layer through a process of preparing another first insulator layer having the first Ni content rate, a process of forming another coil conductor, which constitutes the helical coil, on the first insulator layer, and a process of forming a third insulator layer on a portion of the another first insulator layer other than the coil conductor, the third insulator layer having a second Bi content rate lower than the first Bi content rate and a third Ni content rate higher than the first Ni content rate, and a step of laminating the first unit layer and the second unit layer.

In another more specific embodiment, the step of forming the laminate may further include a step of forming a third unit layer through a process of preparing another first insulator layer having the first Ni content rate, a process of forming another coil conductor, which constitutes the helical coil, on the another first insulator layer, and a process of forming another second insulator layer and a third insulator layer on portions of the first insulator layer other than the coil conductor, the third insulator layer having a second Bi content rate lower than the first Bi content rate and a third Ni content rate higher than the first Ni content rate, and a step of laminating the first unit layer and the third unit layer.

In yet another more specific embodiment, a thickness of each first insulator layer may be smaller than a thickness of each of the second insulator layer and the third insulator layer.

In still another more specific embodiment, the thickness of the first insulator layer may be in the range of 5 μm to 35 μm.

In another more specific embodiment, the first insulator layer may be a non-magnetic layer having a Ni content rate of zero.

In another more specific embodiment, given that a portion of the first insulator layer, the portion being sandwiched between the coil conductors from both sides in a lamination direction, is a first portion, and a portion of the first insulator layer, the portion being sandwiched between the second insulator layers from both sides in the lamination direction, is a second portion, after the step of firing the laminate, a Ni content rate in the first portion may be lower than a Ni content rate in the second portion, and the Ni content rate in the second portion ay be lower than the Ni content rate in the second insulator layer.

In still another more specific embodiment, given that a portion of the first insulator layer, the portion being sandwiched between the third insulator layers from both sides in a lamination direction, is a third portion, after the step of firing the laminate, a Ni content rate in the third portion may be lower than the Ni content rate in the second portion and may be lower than the Ni content rate in the third insulator layer.

In another aspect of the disclosure, an electronic component includes a first unit layer having a first insulator layer in form of a sheet, a coil conductor formed on the first insulator layer, and a second insulator layer formed on a portion of the first insulator layer other than the coil conductor. A helical coil is constituted with the first unit layer laminated in plural and with the coil conductor connected in plural to each other, and wherein, given that a portion of the first insulator layer, the portion being sandwiched between the coil conductors from both sides in a lamination direction, is a first portion, and a portion of the first insulator layer, the portion being sandwiched between the second insulator layers from both sides in the lamination direction, is a second portion, a Ni content rate in the first portion is lower than a Ni content rate in the second portion, and the Ni content rate in the second portion is lower than a Ni content rate in the second insulator layer.

In a more specific embodiment, the electronic component may further include a second unit layer having a first insulator layer in form of a sheet, a coil conductor formed on the first insulator layer, and a third insulator layer formed on a portion of the first insulator layer other than the coil conductor. A helical coil may be constituted with the first unit layer and the second unit layer laminated and with the coil conductor connected in plural to each other, and wherein, given that a portion of the first insulator layer, the portion being sandwiched between the third insulator layers from both sides in the lamination direction, is a third portion, a Ni content rate in the third portion may be lower than the Ni content rate in the second portion and may be lower than a Ni content rate in the third insulator layer.

In another more specific embodiment, the electronic component may further includes a third unit layer having a first insulator layer in form of a sheet, a coil conductor formed on the first insulator layer, and the second insulator layer and a third insulator layer which are formed on portions of the first insulator layer other than the coil conductor. A helical coil may be constituted with the first unit layer and the third unit layer laminated and with the coil conductor connected in plural to each other, and wherein, given that a portion of the first insulator layer, the portion being sandwiched between the third insulator layers from both sides in the lamination direction, is a third portion, a Ni content rate in the third portion may be lower than the Ni content rate in the second portion and may be lower than a Ni content rate in the third insulator layer.

### BRIEF DESCRIPTION OF DRAWINGS

FIG. 1 is a perspective view illustrating an external appearance of each of electronic components according to exemplary embodiments.

FIG. 2 is an exploded perspective view of a laminate of the electronic component according to one exemplary embodiment.

FIG. 3 is a sectional structural view of the electronic component taken along a line A-A in FIG. 1.

FIG. 4 is a graph plotting simulation results in a first model and a second model.

FIG. 5 is a sectional structural view of an electronic component according to a first exemplary modification.

FIG. 6 is a graph plotting simulation results in a third model and a fourth model.

FIG. 7 is a sectional structural view of an electronic component according to a second exemplary modification.

FIG. 8 is a sectional structural view of an electronic component according to a third exemplary modification.

FIG. 9 is a sectional structural view of a multilayer coil component of open magnetic path type, which is described in Patent Literature 1.

### DETAILED DESCRIPTION

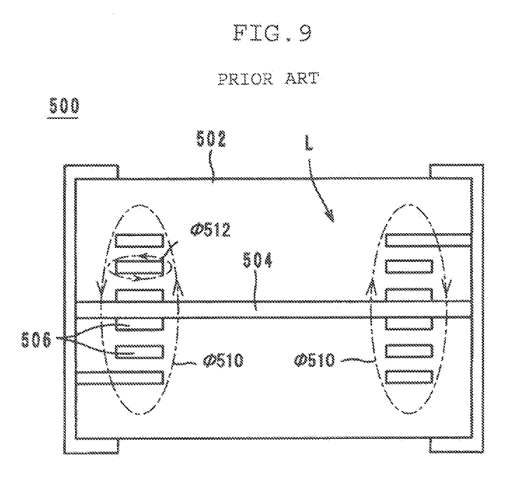

The inventor realized that in the multilayer coil component 500 of open magnetic path type shown in FIG. 9, a magnetic flux φ 512 circles around each of the coil conductors 506 further exists in addition to the magnetic flux φ 510 circling around the coil L. The magnetic flux φ 512 serves also as a factor causing the magnetic saturation in the multilayer coil component 500 of open magnetic path type.

Embodiments of electronic components and manufacturing methods for the electronic components according to the present disclosure can address the above shortcomings related to magnetic saturation.

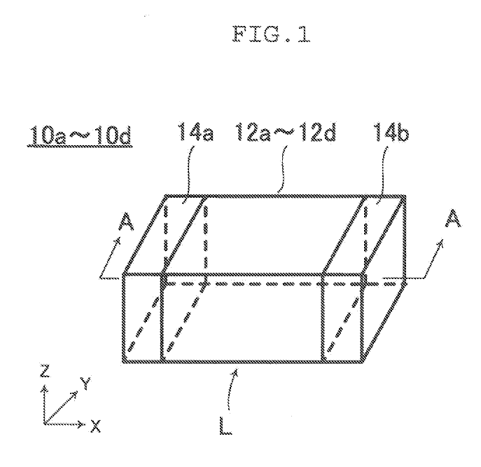

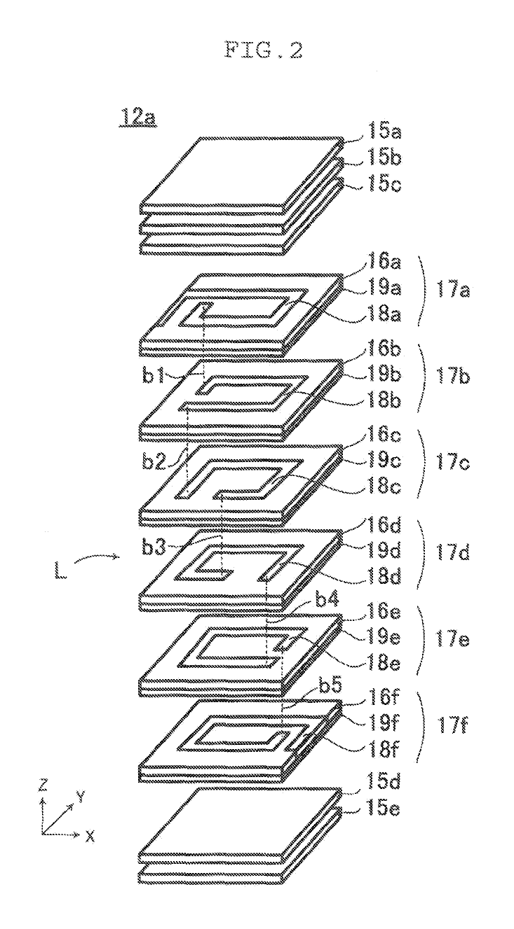

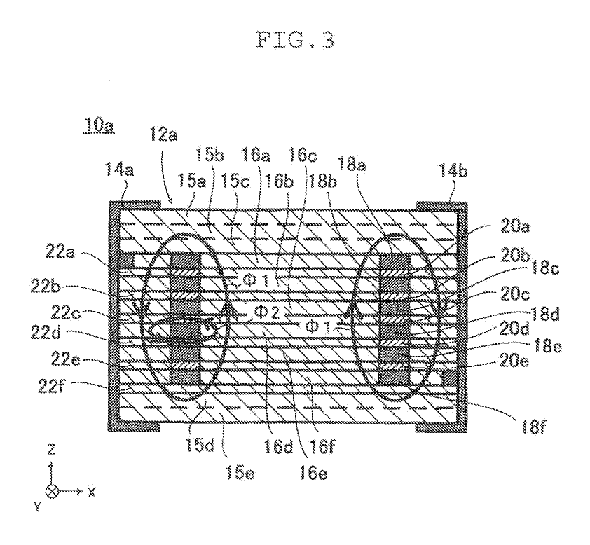

Electronic components according to exemplary embodiments will now be described with reference to the drawings. FIG. 1 is a perspective view illustrating an external appearance of each of electronic components 10a to 10d according to the exemplary embodiments. FIG. 2 is an exploded perspective view of a laminate 12a of the electronic component 10a according to one embodiment. FIG. 3 is a sectional structural view of the electronic component 10a taken along a line A-A in FIG. 1. More specifically, FIG. 2 illustrates the laminate 12a before firing. On the other hand, FIG. 3 illustrates the electronic component 10a after the firing. In the following description, a lamination direction of the electronic component 10a is defined as a z-axis direction, a direction along a long side of the electronic component 10a is defined as an x-axis direction, and a direction along a short side of the electronic component 10a is defined as a y-axis direction. An x-axis, a y-axis, and a z-axis are orthogonal to one another.

The electronic component 10a includes, as illustrated in FIG. 1, the laminate 12a and outer electrodes 14a and 14b. The laminate 12a has a rectangular parallelepiped shape and incorporates a coil L.

The outer electrodes 14a and 14b are each electrically connected to the coil L and are provided on lateral surfaces of the laminate 12a, which are opposed to each other. In this embodiment, the outer electrodes 14a and 14b are disposed so as to cover respective lateral surfaces, which are positioned at respective ends of the laminate 12a in the x-axis direction.

As illustrated in FIG. 2, the laminate 12a is made up of exterior insulator layers 15a to 15e, the first insulator layers 19a to 19f, second insulator layers 16a to 16f, coil conductors 18a to 18f, and via hole conductors b1 to b5.

The exterior insulator layers 15a to 15e are each an insulator layer, which has a rectangular shape and which has a first bismuth (Bi) content rate and a second nickel (Ni) content rate higher than a first Ni content rate, similarly to the second insulator layers 16a to 16f described later. In other words, each exterior insulator layer is a magnetic layer in the form of one sheet made of Ni—Cu—Zn based ferrite containing Bi. The exterior insulator layers 15c, 15b and 15a are laminated in the order named, as illustrated, on the more positive side in the z-axis direction than a region where the coil conductors 18a to 18f are disposed, and they constitute an outer layer. Further, the exterior insulator layers 15d and 15e are laminated in the order named, as illustrated, on the more negative side in the z-axis direction than the region where the coil conductors 18a to 18f are disposed, and they constitute another outer layer.

The first insulator layers 19a to 19f are each an insulator layer, which has a rectangular shape as illustrated in FIG. 2, and which has the first Ni content rate. In this embodiment, the first insulator layers 19a to 19f are each a non-magnetic layer made of Cu-Zn based ferrite having the Ni content rate of zero. It is to be noted that the first insulator layers 19a to 19f are non-magnetic layers before the firing, but they partially become magnetic layers after the firing as described later.

Each of the coil conductors 18a to 18f is made of a conductive material, i.e., Ag, and has a length of ⅞ turn as illustrated in FIG. 2. The coil conductors 18a to 18f constitute the coil L in cooperation with the via hole conductors b1 to b5. The coil conductors 18a to 18f are provided on the first insulator layers 19a to 19f, respectively. Further, one end of the coil conductor 18a is led out on the first insulator layer 19a to its short side on the negative side in the x-axis direction, thereby constituting a lead conductor. The one end of the coil conductor 18a is connected to the outer electrode 14a in FIG. 1. One end of the coil conductor 18f is led out on the first insulator layer 19f to its short side on the positive side in the x-axis direction, thereby constituting a lead conductor. The one end of the coil conductor 18f is connected to the outer electrode 14b in FIG. 1. Moreover, the coil conductors 18a to 18f overlap with one another and form one rectangular ring in a plan view looking from the z-axis direction.

As illustrated in FIG. 2, the via hole conductors b1 to b5 penetrate through the first insulator layers 19a to 19e in the z-axis direction, respectively, thereby connecting adjacent two conductors among the coil conductors 18a to 18f in the z-axis direction. In more detail, the via hole conductor b1 connects the other end of the coil conductor 18a and one end of the coil conductor 18b. The via hole conductor b2 connects the other end of the coil conductor 18b and one end of the coil conductor 18c. The via hole conductor b3 connects the other end of the coil conductor 18c and one end of the coil conductor 18d. The via hole conductor b4 connects the other end of the coil conductor 18d and one end of the coil conductor 18e. The via hole conductor b5 connects the other end of the coil conductor 18e and the other end of the coil conductor 18f (as mentioned above, the one end of the coil conductor 18f constitutes the lead conductor). Thus, the coil conductors 18a to 18f and the via hole conductors b1 to b5 constitute the helical coil L having a coil axis that extends in the z-axis direction.

As illustrated in FIG. 2, the second insulator layers 16a to 16f are disposed on portions of the first insulator layers 19a to 19f other than the coil conductors 18a to 18f, respectively. Accordingly, respective principal surfaces of the first insulator layers 19a to 19f are covered with the second insulator layers 16a to 16f and the coil conductors 18a to 18f. Further, a principal surface of each of the second insulator layers 16a to 16f and a principal surface of corresponding one of the coil conductors 18a to 18f constitute substantial one plane, and those principal surfaces are flush with each other. Moreover, the second insulator layers 16a to 16f are each an insulator layer having the first Bi content rate and the second Ni content rate higher than the first Ni content rate. Stated another way, in this embodiment, the second insulator layers 16a to 16f are each a magnetic layer made of Ni—Cu—Zn based ferrite containing Bi.

Here, each of the first insulator layers 19a to 19f has a smaller thickness than each of the second insulator layers 16a to 16f. More specifically, each of the first insulator layers 19a to 19f is 5 μm or more and 35 μm or less in thickness.

The first insulator layers 19a to 19f, the second insulator layers 16a to 16f, and the coil conductors 18a to 18f constitute first unit layers 17a to 17f, respectively. The first unit layers 17a to 17f are successively laminated in the order named, as illustrated, between the exterior insulator layers 15a to 15c and the exterior insulator layers 15d and 15e. In this way, the laminate 12a is constructed.

The laminate 12a thus obtained is fired and the outer electrodes 14a and 14b are then formed thereon, whereby the electronic component 10a has a sectional structure illustrated in FIG. 3. More specifically, during the firing of the laminate 12a, the Ni content rate in a part of each of the first insulator layers 19a to 19f is increased to be higher than the first Ni content rate. Stated another way, parts of the first insulator layers 19a to 19f are each changed from a non-magnetic layer to a magnetic layer.

In more detail, as illustrated in FIG. 3, the first insulator layers 19a to 19f in the electronic component 10a include first portions 20a to 20e and second portions 22a to 22f. The first portions 20a to 20e are portions of the first insulator layers 19a to 19e, which are each sandwiched between adjacent two conductors among the coil conductors 18a to 18f from both sides facing in the z-axis direction. More specifically, the first portion 20a is a portion of the first insulator layer 19a sandwiched between the coil conductor 18a and the coil conductors 18b. The first portion 20b is a portion of the first insulator layer 19b sandwiched between the coil conductor 18b and the coil conductors 18c. The first portion 20c is a portion of the first insulator layer 19c sandwiched between the coil conductor 18c and the coil conductors 18d. The first portion 20d is a portion of the first insulator layer 19d sandwiched between the coil conductor 18d and the coil conductors 18e. The first portion 20e is a portion of the first insulator layer 19e sandwiched between the coil conductor 18e and the coil conductors 18f.

The second portions 22a to 22f are portions of the first insulator layers 19a to 19f other than the first portions 20a to 20e. However, in the first insulator layer 19f, the first portion 20a is not present and only the second portion 22f is present. The reason is that the first insulator layer 19f is positioned on the more negative side in the z-axis direction than the coil conductor 18f, which is positioned farthest on the negative side in the z-axis direction.

The Ni content rate in each of the first portions 20a to 20e is lower than that in each of the second portions 22a to 22f. In this embodiment, the first portions 20a to 20e do not contain Ni. Thus, the first portions 20a to 20e are non-magnetic layers. On the other hand, the second portions 22a to 22f contain Ni. Thus, the second portions 22a to 22f are magnetic layers. Furthermore, the Ni content rate in each of the second portions 22a to 22f is lower than that in each of the second insulator layers 16a to 16f.

An exemplary manufacturing method for the electronic component 10a will now be described with reference to the drawings. The manufacturing method for the electronic component 10a is carried out when simultaneously producing the electronic components 10a.

First, ceramic green sheets to be the first insulator layers 19a to 19f, illustrated in FIG. 2, are prepared. More specifically, ferric oxide (Fe₂O₃), zinc oxide (ZnO), and copper oxide (CuO) in respective amounts weighed at a predetermined ratio are put, as raw materials, in a ball mill and are subjected to wet mixing. The obtained mixture is dried and ground. The obtained powder is calcined at 800° C. for 1 hour. The calcined powder is subjected to wet grinding in a ball mill and is disintegrated after drying, whereby ferrite ceramic powder is obtained.

A water based binder (e.g., vinylacetate or water-soluble acryl), an organic binder (e.g., polyvinyl butyral), a dispersant, and a defoaming agent are added to the ferrite ceramic powder, and the resulting mixture is mixed in a ball mill. Ceramic slurry is then obtained through steps of depressurization and defoaming. The obtained ceramic slurry is coated in the form of a sheet over a carrier sheet by the doctor blade method and is dried. The ceramic green sheets to be the first insulator layers 19a to 19f are thereby fabricated.

Next, ceramic green sheets to be the exterior insulator layers 15a to 15e, illustrated in FIG. 2, are prepared. More specifically, ferric oxide (Fe₂O₃), zinc oxide (ZnO), nickel oxide (NiO), copper oxide (CuO), and bismuth oxide (Bi₂O₃) in respective amounts weighed at a predetermined ratio are put, as raw materials, in a ball mill and are subjected to wet mixing. The obtained mixture is dried and ground. The obtained powder is calcined at 800° C. for 1 hour. The calcined powder is subjected to wet grinding in a ball mill and is disintegrated after drying, whereby ferrite ceramic powder is obtained.

A water based binder (e.g., vinylacetate or water-soluble acryl), an organic binder (e.g., polyvinyl butyral), a dispersant, and a defoaming agent are added to the ferrite ceramic powder, and the resulting mixture is mixed in a ball mill. Ceramic slurry is then obtained through steps of depressurization and defoaming. A proportion of the bismuth oxide in the ceramic slurry is adjusted to 1.5% by weight in terms of a raw-material ratio. The obtained ceramic slurry is coated in the form of a sheet over a carrier sheet by the doctor blade method and is dried. The ceramic green sheets to be the exterior insulator layers 15a to 15e are thereby fabricated.

Next, a ceramic paste for ceramic paste layers to be the second insulator layers 16a to 16f, illustrated in FIG. 2, is prepared. More specifically, ferric oxide (Fe₂O₃), zinc oxide (ZnO), nickel oxide (NiO), copper oxide (CuO), and bismuth oxide (Bi₂O₃) in respective amounts weighed at a predetermined ratio are put, as raw materials, in a ball mill and are subjected to wet mixing. The obtained mixture is dried and ground. The obtained powder is calcined at 800° C. for 1 hour. The calcined powder is subjected to wet grinding in a ball mill and is disintegrated after drying, whereby ferrite ceramic powder is obtained.

A mixture of a binder (e.g., ethyl cellulose, PVB, methyl cellulose, or acryl resin), terpineol, a dispersant, and a plasticizer is added to the ferrite ceramic powder and kneaded, whereby the ceramic paste for the ceramic paste layers to be the second insulator layers 16a to 16f is obtained. Here, a proportion of the bismuth oxide in the ceramic paste is adjusted to 1.5% by weight in terms of a raw-material ratio.

Next, as illustrated in FIG. 2, the via hole conductors b1 to b5 are formed in the respective ceramic green sheets to be the first insulator layers 19a to 19e. More specifically, via holes are formed by emitting a laser beam to the ceramic green sheets to be the first insulator layers 19a to 19e. The formed via holes are then filled with a conductive paste made of, e.g., Ag, Pd, Cu or Au, by print coating, for example. The conductive paste may be made of Ag alloy, Pd alloy, Cu alloy or Au alloy.

Next, as illustrated in FIG. 2, the coil conductors 18a to 18f are formed on the respective ceramic green sheets to be the first insulator layers 19a to 19f. More specifically, the coil conductors 18a to 18f are formed by coating a conductive paste, which is primarily made of, e.g., Ag, Pd, Cu, Au or an alloy thereof, over the ceramic green sheets to be the first insulator layers 19a to 19f by screen printing, for example. It is to be noted that a step of forming the coil conductors 18a to 18f and a step of filling the conductive paste in the via holes may be performed in the same step.

Next, as illustrated in FIG. 2, the ceramic paste layers to be the second insulator layers 16a to 16f are formed on portions of the respective ceramic green sheets, which are to be the first insulator layers 19a to 19f, other than the coil conductors 18a to 18f. More specifically, the ceramic paste layers to be the second insulator layers 16a to 16f are formed by coating the ceramic paste with screen printing or some other suitable method. Ceramic green layers to be the first unit layers 17a to 17f, illustrated in FIG. 2, are formed through the above-described steps.

Next, as illustrated in FIG. 2, the ceramic green sheets to be the exterior insulator layers 15a to 15c, the ceramic green layers to be the first unit layers 17a to 17f, and the ceramic green sheets to be the exterior insulator layers 15d and 15e are successively laminated in the order named and press-bonded, whereby an unfired mother laminate is obtained. A process of laminating and press-bonding the ceramic green sheets to be the exterior insulator layers 15a to 15c, the ceramic green layers to be the first unit layers 17a to 17f, and the ceramic green sheets to be the exterior insulator layers 15d and 15e is performed by laminating them one by one, tentatively press-bonding the laminated layers, and then subjecting the unfired mother laminate to main press-bonding under pressure with an isostatic press, for example.

In the lamination step, the ceramic green layers to be the first unit layers 17a to 17f are successively laminated in the z-axis direction, whereby the coil L is formed. Thus, in the unfired mother laminate, as illustrated in FIG. 2, the coil conductors 18a to 18f and the first insulator layers 19a to 19f are alternately arranged in the z-axis direction.

Next, the mother laminate is cut into the laminate 12a having a predetermined size by a cutting blade. As a result, the laminate 12a, which is unfired, is obtained. The unfired laminate 12a is then subjected to debinding and firing. The debinding is performed in a low oxygen atmosphere on conditions of, e.g., 500° C. for 2 hours. The firing is performed on conditions of, e.g., 870° C. to 900° C. for 2.5 hours.

During the firing, there occurs diffusion of Ni into the first insulator layers 19a to 19f from the second insulator layers 16a to 16f and the exterior insulator layer 15d. In more detail, as illustrated in FIG. 3, because the second portions 22a to 22f of the first insulator layers 19a to 19f are contacted with the second insulator layers 16a to 16f and the exterior insulator layer 15d, and each of those layers containing Ni, Ni is diffused into the second portions 22a to 22f from the second insulator layers 16a to 16f and the exterior insulator layer 15d. Therefore, the second portions 22a to 22f become magnetic layers. However, the Ni content rate in each of the second portions 22a to 22f is lower than the second Ni content rate in each of the second insulator layers 16a to 16f and the exterior insulator layer 15d.

Here, Bi contained in the second insulator layers 16a to 16f and the exterior insulator layer 15d has a very important role in relation to the diffusion of Ni.

When Ni contained the second insulator layers 16a to 16f and the exterior insulator layer 15d is diffused into the first insulator layers 19a to 19f, the diffusion of Ni is promoted as those layers contain Bi in larger amount. In other words, Bi contained in the second insulator layers 16a to 16f and the exterior insulator layer 15d serves to promote the diffusion of Ni. From point of view described above, in the present embodiment, Bi is contained in the second insulator layers 16a to 16f and the exterior insulator layer 15d.

On the other hand, because the first portions 20a to 20e of the first insulator layers 19a to 19e are not contacted with the second insulator layers 16a to 16f and the exterior insulator layer 15d (i.e., the first portions 20a to 20e do not overlap the second insulator layers 16a to 16f as viewed from the coil axis or lamination direction), Ni is not diffused into the first portions 20a to 20e from the second insulator layers 16a to 16f and the exterior insulator layer 15d. Therefore, the first portions 20a to 20e remain as non-magnetic layers not containing Ni. It is to be noted that, while the first portions 20a to 20e substantially do not contain Ni, they may contain Ni diffused through the second portions 22a to 22e. Accordingly, the first portions 20a to 20e may contain Ni, but in such a small amount as not exhibiting magnetism. Even in that case, the Ni content rate in each of the first portions 20a to 20e is lower than that in each of the second portions 22a to 22f.

The laminate 12a having been fired is obtained through the above-described steps. The laminate 12a is chamfered by barrel polishing. Silver electrodes to be the outer electrodes 14a and 14b are then formed by coating an electrode paste, which is primarily made of silver, over the surface of the laminate 12a with an immersion process or some other suitable method, and by firing the coated electrode paste. The silver electrodes are fired at 800° for 60 minutes.

Finally, the outer electrodes 14a and 14b are formed by plating Ni/Sn on the surfaces of the silver electrodes. The electronic component 10a, illustrated in FIG. 1, is completed through the above-described steps.

According to the electronic component 10a and the manufacturing method for the same, the occurrence of magnetic saturation due to a magnetic flux circling around each of the coil conductors 18a to 18f can be suppressed as described below. In more detail, while a current flows through the coil L of the electronic component 10a, there is generated, as illustrated in FIG. 3, not only a magnetic flux φ1 that has a relatively long magnetic path circling around the entirety of the coil conductors 18a to 18f, but also a magnetic flux φ2 that has a relatively short magnetic path circling around each of the coil conductors 18a to 18f (FIG. 3 illustrates only the magnetic flux φ2 generated around the coil conductor 18d). As with the magnetic flux φ1, the magnetic flux φ2 may also become a factor causing the magnetic saturation in the electronic component 10a.

To cope with such a problem, in the electronic component 10a fabricated by the manufacturing method described above, the first portions 20a to 20e of the first insulator layers 19a to 19f, each sandwiched between adjacent two conductors among the coil conductors 18a to 18f from both sides facing in the z-axis direction, are provided as non-magnetic layers. Therefore, the magnetic flux φ2 circling around each of the coil conductors 18a to 18f passes through corresponding one of the first portions 20a to 20e that are non-magnetic layers. Hence, a magnetic flux density of the magnetic flux φ2 is prevented from being excessively increased, and the occurrence of the magnetic saturation in the electronic component 10a is suppressed. As a result, a direct current superposition characteristic of the electronic component 10a is improved.

For more positively confirming the advantageous effect of the electronic component 10a and the manufacturing method for the same, the inventor of this application has conducted a computer simulation as described below. More specifically, the inventor has fabricated a first model corresponding to the electronic component 10a, and a second model in which the first insulator layers 19a to 19f of the electronic component 10a are formed as magnetic layers. Simulation conditions are as follows:
Number of turns of the coil L: 8.5 turns
Size of the electronic component: 2.5 mm×2.0 mm×1.0 mm
Thickness of each of the first insulator layers 19a to 19f: 10 μm

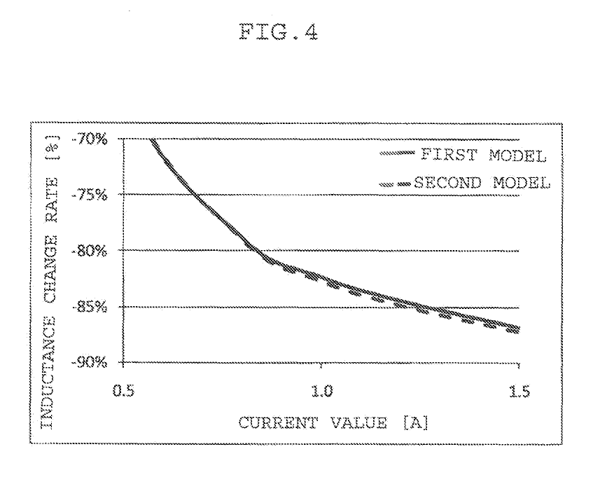

FIG. 4 is a graph depicting the simulation results. The horizontal axis of the graph represents a value of the current applied to each model. The vertical axis of the graph represents an inductance change rate on the basis of an inductance value when the current value is substantially zero (e.g., 0.001 A).

As seen from FIG. 4, an inductance change rate in the first model is smaller than that in the second model even when the current value is increased. It is hence understood that the first model is superior in a direct current superposition characteristic to the second model. This implies that, due to the magnetic flux circling around each coil conductor, the magnetic saturation is more apt to generate in the second model than in the first model. As a result, it is understood that the occurrence of the magnetic saturation due to the magnetic flux φ2 circling around each of the coil conductors 18a to 18f can be suppressed in the electronic component 10a and with the manufacturing method for the same.

Further, according to the electronic component 10a and the manufacturing method for the same, the first portions 20a to 20e serving as non-magnetic layers can be formed with high accuracy. In more detail, as a method of forming a non-magnetic layer in a portion sandwiched between coil conductors in a typical electronic component, it is conceivable, for example, to print a non-magnetic paste over the portion sandwiched between the coil conductors.

With the method of printing the non-magnetic paste, however, there is a possibility that the non-magnetic layer may protrude from the portion sandwiched between the coil conductors due to a printing misalignment and a lamination misalignment. If the non-magnetic layer protrudes from the portion sandwiched between the coil conductors, the protruded non-magnetic layer may impede the magnetic flux circling around the entirety of the coil conductors and having the long magnetic path. Stated another way, not only the intended magnetic flux, but also the other magnetic flux can pass through the non-magnetic layer.

In contrast, according to the electronic component 10a and the manufacturing method for the same, the first portions 20a to 20e serving as non-magnetic layers are formed during the firing after the laminate 12a has been fabricated. Therefore, the first portions 20a to 20e are each prevented from protruding from the portion sandwiched between adjacent two of the coil conductors 18a to 18f due to a printing misalignment and a lamination misalignment. Thus, according to the electronic component 10a and the manufacturing method for the same, the first portions 20a to 20e serving as non-magnetic layers can be formed with high accuracy. As a result, passage of the magnetic flux φ1 other than the intended magnetic flux φ2 through the non-magnetic layer is suppressed.

Moreover, in the electronic component 10a, the first unit layers 17a to 17f are successively laminated in the order named between the exterior insulator layers 15a to 15c and the exterior insulator layers 15d and 15e. With such an arrangement, the non-magnetic layers are positioned only in the first portions 20a to 20e each sandwiched between adjacent two of the coil conductors 18a to 18f. Thus, a non-magnetic layer extending across the coil L does not exist.

Still further, in the electronic component 10a and the manufacturing method for the same, the thickness of each of the first insulator layers 19a to 19f is preferably 5 μm or more and 35 μm or less.

If the thickness of each of the first insulator layers 19a to 19f is less than 5 μm, a difficulty would arise in fabricating the ceramic green sheets that are to be the first insulator layers 19a to 19f. On the other hand, if the thickness of each of the first insulator layers 19a to 19f is more than 35 μm, Ni would be not sufficiently diffused and a difficulty would arise in converting the second portions 22a to 22f to the magnetic layers.

In the electronic component 10a, a non-magnetic layer extending across the coil L does not exist. However, a non-magnetic layer may exist in a portion of the electronic component 10a other than the first portions 20a to 20e. The reason is that the presence of such a non-magnetic layer can be used to adjust the direct current superposition characteristic and the inductance value of the electronic component. Electronic components according to modifications, in which a non-magnetic layer is disposed in a portion other than the first portions 20a to 20e, will be described below.

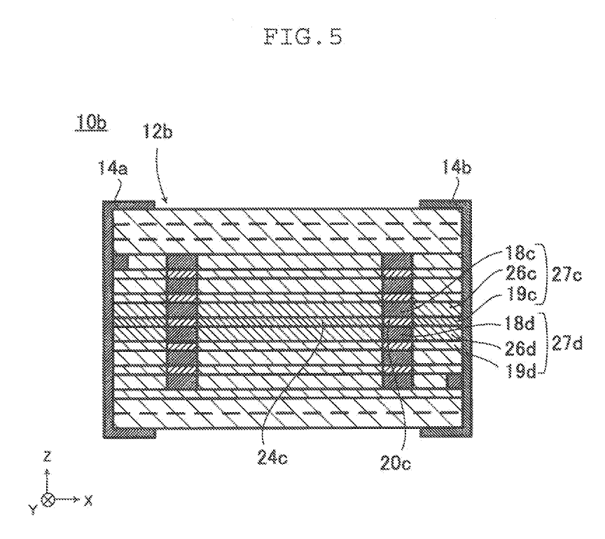

An exemplary electronic component 10b and an exemplar manufacturing method for the same according to a first exemplary modification will now be described with reference to the drawings. FIG. 5 is a sectional structural view of the electronic component 10b according to the first exemplary modification. For the sake of simplicity of the drawing, some of reference symbols denoting the same components as those in FIG. 3 are not shown in FIG. 5.

The electronic component 10b differs from the electronic component 10a in that, in the electronic component 10b, third insulator layers 26c and 26d, each having a second Bi content rate lower than the first Bi content rate and a third Ni content rate higher than the first Ni content rate, are provided instead of the second insulator layers 16c and 16d as the magnetic layers.

Here, the third insulator layers 26c and 26d are formed on or provided on portions of the first insulator layers 19c and 19d other than the coil conductors 18c and 18d, respectively. Accordingly, principal surfaces of the first insulator layers 19c and 19d are covered with the third insulator layers 26c and 26d and the coil conductors 18c and 18d. Further, corresponding respective principal surfaces of the third insulator layers 26c and 26d and the coil conductors 18c and 18d individually constitute one plane, and they are flush with each other. Moreover, the thickness of each of the first insulator layers 19c and 19d is smaller than that of each of the third insulator layers 26c and 26d.

In the electronic component 10b according to the first exemplary modification, during the firing, Ni is diffused into the first insulator layer 19c from the third insulator layers 26c and 26d.

In more detail, as illustrated in FIG. 5, because a third portion 24c of the first insulator layer 19c (namely, a portion of the first insulator layer 19c other than the first portion 20c, i.e., other than the portion sandwiched between the coil conductor 18c and the coil conductor 18d) is contacted with the third insulator layers 26c and 26d, Ni is diffused into the third portion 24c from the third insulator layers 26c and 26d.

However, an amount of Ni diffused into the third portion 24c from the third insulator layers 26c and 26d is smaller than that diffused into the first insulator layers 19a, 19b, 19d and 19e from the second insulator layers 16a, 16b, 16e and 16f and the exterior insulator layer 15d.

As described above, the reason that a smaller amount of Ni diffuses into third portion 24c is that Bi has a very important role in the diffusion of Ni, and Bi contributes to promoting the diffusion of Ni. On the other hand, the Bi content rate in each of the third insulator layers 26c and 26d is lower than that in each of the second insulator layers 16a, 16b, 16e and 16f. Therefore, the amount of Ni diffused into the third portion 24c of the first insulator layer 19c is reduced.

Accordingly, the third portion 24c becomes a non-magnetic layer containing Ni in such a small amount as not exhibiting magnetism, or a non-magnetic layer containing Ni only in surface layer portions positioned very close to both surfaces thereof, which are contacted with the third insulator layers 26c and 26d.

Here, the Ni content rate in the third portion 24c is lower than that in each of the second portions 22a, 22b, 22d and 22e, and is also lower than that in each of the third insulator layers 26c and 26d.

Consequently, in the electronic component 10b, the third portion 24c serving as the non-magnetic layer is formed on or provided on both the inner and outer sides of the coil L. This allows the magnetic flux φ1 to pass through the third portion 24c that is the non-magnetic layer. As a result, in the electronic component 10b, the occurrence of the magnetic saturation due to the magnetic flux φ1 is suppressed.

As an exemplary manufacturing method for the electronic component 10b, a ceramic paste for ceramic paste layers to be the third insulator layers 26c and 26d are first prepared as follows.

More specifically, ferric oxide (Fe₂O₃), zinc oxide (ZnO), nickel oxide (NiO), copper oxide (CuO), and bismuth oxide (Bi₂O₃) in respective amounts weighed at a predetermined ratio are put, as raw materials, in a ball mill and are subjected to wet mixing. The obtained mixture is dried and ground. The obtained powder is calcined at 800° C. for 1 hour. The calcined powder is subjected to wet grinding in a ball mill and is disintegrated after drying, whereby ferrite ceramic powder is obtained.

A mixture of a binder (e.g., ethyl cellulose, PVB, methyl cellulose, or acryl resin), terpineol, a dispersant, and a plasticizer is added to the ferrite ceramic powder and kneaded, whereby the ceramic paste for the ceramic paste layers to be the third insulator layers 26c and 26d is obtained. Here, a proportion of the bismuth oxide in the ceramic paste is adjusted to 0.2% by weight in terms of a raw-material ratio.

Next, the via hole conductors b3 and b4 are formed in the respective ceramic green sheets to be the first insulator layers 19c and 19d. Since a method of forming the via hole conductors b3 and b4 has been described above, the description of the method is not repeated here.

Next, the coil conductors 18c and 18d are formed on the respective ceramic green sheets to be the first insulator layers 19c and 19d. Since a method of forming the coil conductors 18c and 18d has been described above, the description of the method is not repeated here.

Next, the ceramic paste layers to be the third insulator layers 26c and 26d are formed on portions of the respective ceramic green sheets, which are to be the first insulator layers 19c and 19d, other than the coil conductors 18c and 18d.

More specifically, the ceramic paste layers to be the third insulator layers 26c and 26d are formed by coating the ceramic paste with screen printing or some other suitable method.

Ceramic green layers to be second unit layers 27c and 27d are formed through the above-described steps.

Next, the ceramic green sheets to be the exterior insulator layers 15a to 15c, the ceramic green layers to be the first unit layers 17a to 17b, the second unit layers 27c and 27d, and the first unit layers 17e to 17f, and the ceramic green sheets to be the exterior insulator layers 15d and 15e are successively laminated in the order named and press-bonded, whereby an unfired mother laminate is obtained. The other steps in the method of manufacturing the electronic component 10b are similar to those in the method of manufacturing the electronic component 10a, and hence the description of the other steps is not repeated here.

For more positively confirming the advantageous effect of the electronic component 10b and the manufacturing method for the same, the inventor has conducted a computer simulation as described below. More specifically, the inventor has fabricated a third model corresponding to the electronic component 10b, and a fourth model in which the first insulator layers 19a, 19b, 19d, 19e and 19f of the electronic component 10b are formed as magnetic layers, whereas the first insulator layer 19c is formed as a non-magnetic layer. Simulation conditions are as follows:
Number of turns of the coil L: 8.5 turns
Size of the electronic component: 2.5 mm×2.0 mm×1.0 mm
Thickness of each of the first insulator layers 19a to 19f: 10 μm

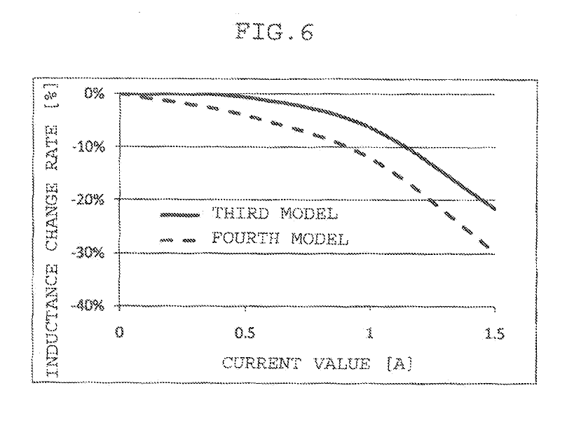

FIG. 6 is a graph depicting the simulation results. The horizontal axis of the graph represents a value of the current applied to each model. The vertical axis of the graph represents an inductance change rate on the basis of an inductance value when the current value is substantially zero (e.g., 0.01 A).

As seen from FIG. 6, an inductance change rate in the third model is smaller than that in the fourth model even when the current value is increased. It is hence understood that the third model is superior in a direct current superposition characteristic to the fourth model. This implies that, due to the magnetic flux circling around each coil conductor, the magnetic saturation is more apt to generate in the fourth model than in the third model. As a result, it is understood that the occurrence of the magnetic saturation due to the magnetic fluxes φ1 and φ2 circling around each of the coil conductors 18a to 18f can be suppressed in the electronic component 10b and with the manufacturing method for the same.

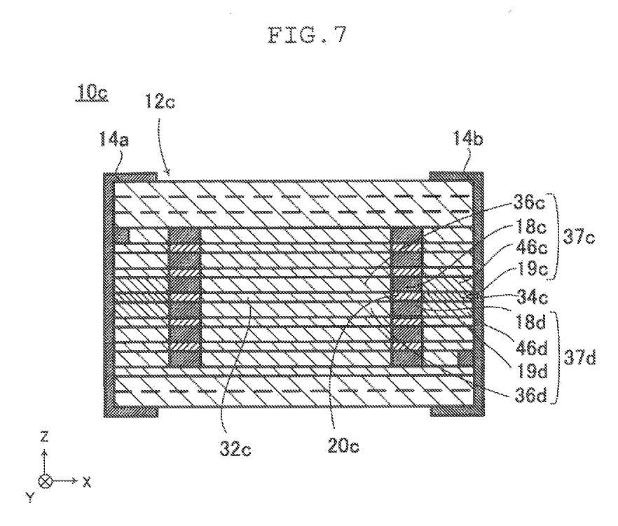

An exemplary electronic component 10c and an exemplary manufacturing method for the same according to a second exemplary modification will now be described with reference to the drawing. FIG. 7 is a sectional structural view of the electronic component 10c according to the second modification. For the sake of simplicity of the drawing, some of reference symbols denoting the same components as those in FIG. 3 are not shown in FIG. 7.

The electronic component 10c differs from the electronic component 10a in that, in the electronic component 10c, second insulator layers 36c and 36d and third insulator layers 46c and 46d, where each of the third insulator layers 46c and 46d have a second Bi content rate lower than the first Bi content rate and a third Ni content rate higher than the first Ni content rate, are provided instead of the second insulator layers 16c and 16d, which are magnetic layers.

Here, the second insulator layer 36c and the third insulator layer 46c, and the second insulator layer 36d and the third insulator layer 46d are formed on or provided on portions of the first insulator layers 19c and 19d other than the coil conductors 18c and 18d, respectively.

More specifically, the third insulator layers 46c and 46d are formed on portions of the respective ceramic green sheets, which are to be the first insulator layers 19c and 19d, on the outer side of the coil conductors 18c and 18d. The second insulator layers 36c and 36d are formed on portions of the respective ceramic green sheets, which are to be the first insulator layers 19c and 19d, on the inner side of the coil conductors 18c and 18d.

Principal surfaces of the first insulator layers 19c and 19d are covered with the second insulator layers 36c and 36d, the third insulator layers 46c and 46d, and the coil conductors 18c and 18d. Further, corresponding respective principal surfaces of the second insulator layers 36c and 36d, the third insulator layers 46c and 46d, and the coil conductors 18c and 18d individually constitute one plane, and they are flush with each other. Moreover, the thickness of each of the first insulator layers 19c and 19d is smaller than that of each of the second insulator layers 36c and 36d and the third insulator layers 46c and 46d.

In the electronic component 10c according to the second modification, during the firing, Ni is diffused into the first insulator layer 19c from the third insulator layers 46c and 46d.

In more detail, as illustrated in FIG. 7, because a third portion 34c of the first insulator layer 19c (i.e., a portion of the first insulator layer 19c sandwiched between the third insulator layer 46c and the third insulator layer 46d) is contacted with the third insulator layers 46c and 46d, Ni is diffused into the third portion 34c from the third insulator layers 46c and 46d.

However, an amount of Ni diffused into the third portion 34c from the third insulator layers 46c and 46d is smaller than that diffused into the first insulator layer 19c from the second insulator layers 36c and 36d.

As described above, the reason that a smaller amount of Ni diffuses into the third portion 34c is that Bi has a very important role in the diffusion of Ni, and Bi contributes to promoting the diffusion of Ni. On the other hand, the Bi content rate in each of the third insulator layers 46c and 46d is lower than that in each of the second insulator layers 36c and 36d. Therefore, the amount of Ni diffused into the third portion 34c of the first insulator layer 19c is reduced.

Accordingly, the third portion 34c contains Ni in such a small amount as to not exhibit magnetism and becomes a non-magnetic layer, or a non-magnetic layer containing Ni only in surface layer portions positioned very close to both surfaces thereof, which are contacted with the third insulator layers 46c and 46d.

Here, the Ni content rate in the third portion 34c is lower than that in each of the second portions 22a, 22b, 22d, 22e, 22f, and 32c, and is also lower than that in each of the third insulator layers 46c and 46d. The second portion 32c is a portion sandwiched between the second insulator layers 36c and 36d of the first insulator layer 19d.

Consequently, in the electronic component 10c, the third portion 34c serving as the non-magnetic layer is formed on or provided on the outer side of the coil L. This allows the magnetic flux φ1 to pass through the third portion 34c that is the non-magnetic layer. As a result, in the electronic component 10c, the occurrence of the magnetic saturation due to the magnetic flux φ1 is suppressed.

As an exemplary manufacturing method for the electronic component 10c, respective ceramic pastes for ceramic paste layers to be the second insulator layers 36c and 36d and the third insulator layers 46c and 46d are first prepared. In practice, the respective ceramic pastes can be prepared in similar manners to those for preparing the ceramic paste for the second insulator layers 16c and 16d and the ceramic paste for the third insulator layers 26c and 26d. Hence, the description of the manners for preparing the ceramic pastes is not repeated here.

Next, the via hole conductors b3 and b4 are formed in the respective ceramic green sheets to be the first insulator layers 19c and 19d. Since a method of forming the via hole conductors b3 and b4 has been described above, the description of the method is not repeated here.

Next, the coil conductors 18c and 18d are formed on the respective ceramic green sheets to be the first insulator layers 19c and 19d. Since a method of forming the coil conductors 18c and 18d has been described above, the description of the method is not repeated here.

Next, the ceramic paste layers to be the second insulator layers 36c and 36d and the ceramic paste layers to be the third insulator layers 46c and 46d are formed on portions of the respective ceramic green sheets, which are to be the first insulator layers 19c and 19d, other than the coil conductors 18c and 18d.

More specifically, the third insulator layers 46c and 46d are formed on portions of the respective ceramic green sheets, which are to be the first insulator layers 19c and 19d, on the outer side of the coil conductors 18c and 18d, and the second insulator layers 36c and 36d are formed on portions of the respective ceramic green sheets, which are to be the first insulator layers 19c and 19d, on the inner side of the coil conductors 18c and 18d.

Thus, the ceramic paste layers to be the second insulator layers 36c and 36d and the third insulator layers 46c and 46d are formed by coating the above-mentioned ceramic pastes with screen printing or some other suitable method.

Ceramic green layers to be third unit layers 37c and 37d are formed through the above-described steps.

Next, the ceramic green sheets to be the exterior insulator layers 15a to 15c, the ceramic green layers to be the first unit layers 17a to 17b, the third unit layers 37c and 37d, and the first unit layers 17e to 17f, and the ceramic green sheets to be the exterior insulator layers 15d and 15e are successively laminated in the order named and press-bonded, whereby an unfired mother laminate is obtained. The other steps in the method of manufacturing the electronic component 10c are similar to those in the method of manufacturing the electronic component 10a, and hence the description of the other steps is not repeated here.

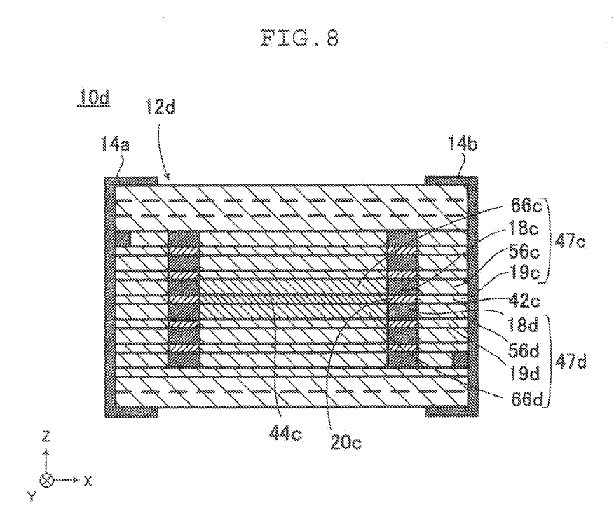

An exemplary electronic component 10d and an exemplary manufacturing method for the same according to a third exemplary modification will be described with reference to the drawing. FIG. 8 is a sectional structural view of the electronic component 10d according to the third modification. For the sake of simplicity of the drawing, some of reference symbols denoting the same components as those in FIG. 3 are not shown in FIG. 8.

The electronic component 10d differs from the electronic component 10a in that, in the electronic component 10d, second insulator layers 56c and 56d and the third insulator layers 66c and 66d, where each of the third insulator layers 66c and 66d having a second Bi content rate lower than the first Bi content rate and a third Ni content rate higher than the first Ni content rate, are provided instead of the second insulator layers 16c and 16d, which are magnetic layers.

Here, the second insulator layer 56c and the third insulator layer 66c, and the second insulator layer 56d and the third insulator layer 66d are formed or provided on portions of the first insulator layers 19c and 19d other than the coil conductors 18c and 18d, respectively.

More specifically, the third insulator layers 66c and 66d are formed on or provided on portions of the respective ceramic green sheets, which are to be the first insulator layers 19c and 19d, on the inner side of the coil conductors 18c and 18d. The second insulator layers 56c and 56d are formed on or provided on portions of the respective ceramic green sheets, which are to be the first insulator layers 19c and 19d, on the outer side of the coil conductors 18c and 18d.

Principal surfaces of the first insulator layers 19c and 19d are covered with the second insulator layers 56c and 56d, the third insulator layers 66c and 66d, and the coil conductors 18c and 18d. Further, corresponding respective principal surfaces of the second insulator layers 56c and 56d, the third insulator layers 66c and 66d, and the coil conductors 18c and 18d individually constitute one plane, and they are flush with each other. Moreover, the thickness of each of the first insulator layers 19c and 19d is smaller than that of each of the second insulator layers 56c and 56d and the third insulator layers 66c and 66d.

In the electronic component 10d according to the third modification, during the firing, Ni is diffused into the first insulator layer 19c from the third insulator layers 66c and 66d.

In more detail, as illustrated in FIG. 8, because a third portion 44c of the first insulator layer 19c (i.e., a portion of the first insulator layer 19c sandwiched between the third insulator layer 66c and the third insulator layer 66d) is contacted with the third insulator layers 66c and 66d, Ni is diffused into the third portion 44c from the third insulator layers 66c and 66d.

However, an amount of Ni diffused into the third portion 44c from the third insulator layers 66c and 66d is smaller than that diffused into the first insulator layer 19c from the second insulator layers 56c and 56d.

As described above, the reason that a smaller amount of Ni diffuses into the third portion 44c is that Bi has a very important role in the diffusion of Ni, and Bi contributes to promoting the diffusion of Ni. On the other hand, the Bi content rate in each of the third insulator layers 66c and 66d is lower than that in each of the second insulator layers 56c and 56d. Therefore, the amount of Ni diffused into the third portion 44c of the first insulator layer 19c is reduced.

Accordingly, the third portion 44c becomes a non-magnetic layer containing Ni in such a small amount as not exhibiting magnetism, or a non-magnetic layer containing Ni only in surface layer portions positioned very close to both surfaces thereof, which are contacted with the third insulator layers 66c and 66d.

Here, the Ni content rate in the third portion 44c is lower than that in each of the second portions 22a, 22b, 22d, 22e, 22f, and 42c, and is also lower than that in each of the third insulator layers 66c and 66d. The second portion 42c is a portion sandwiched between the second insulator layers 56c and 56d of the first insulator layer 19c.

Consequently, in the electronic component 10d, the third portion 44c serving as the non-magnetic layer is formed on the inner side of the coil L. This allows the magnetic flux φ1 to pass through the third portion 44c that is the non-magnetic layer. As a result, in the electronic component 10d, the occurrence of the magnetic saturation due to the magnetic flux φ1 is suppressed.

As an exemplary manufacturing method for the electronic component 10d, respective ceramic pastes for ceramic paste layers to be the second insulator layers 56c and 56d and the third insulator layers 66c and 66d are first prepared. In practice, the respective ceramic pastes can be prepared in similar manners to those for preparing the ceramic paste for the second insulator layers 16c and 16d and the ceramic paste for the third insulator layers 26c and 26d. Hence, the description of the manner for preparing the ceramic pastes is not repeated here.

Next, the via hole conductors b3 and b4 are formed in the respective ceramic green sheets to be the first insulator layers 19c and 19d. Since a method of forming the via hole conductors b3 and b4 has been described above, the description of the method is not repeated here.

Next, the coil conductors 18c and 18d are formed on the respective ceramic green sheets to be the first insulator layers 19c and 19c. Since a method of forming the coil conductors 18c and 18d has been described above, the description of the method is not repeated here.

Next, the ceramic paste layers to be the second insulator layers 56c and 56d and the ceramic paste layers to be the third insulator layers 66c and 66d are formed on portions of the respective ceramic green sheets, which are to be the first insulator layers 19c and 19d, other than the coil conductors 18c and 19d.

More specifically, the third insulator layers 66c and 66d are formed on portions of the respective ceramic green sheets, which are to be the first insulator layers 19c and 19d, on the inner side of the coil conductors 18c and 18d, and the second insulator layers 56c and 56d are formed on portions of the respective ceramic green sheets, which are to be the first insulator layers 19c and 19d, on the outer side of the coil conductors 18c and 18d.

Thus, the ceramic paste layers to be the second insulator layers 56c and 56d and the third insulator layers 66c and 66d are formed by coating the above-mentioned ceramic pastes with screen printing or some other suitable method.

Ceramic green layers to be third unit layers 47c and 47d are formed through the above-described steps.

Next, the ceramic green sheets to be the exterior insulator layers 15a to 15c, the ceramic green layers to be the first unit layers 17a to 17b, the third unit layers 47c and 47d, and the first unit layers 17e to 17f, and the ceramic green sheets to be the exterior insulator layers 15d and 15e are successively laminated in the order named and press-bonded, whereby an unfired mother laminate is obtained. The other steps in the method of manufacturing the electronic component 10d are similar to those in the method of manufacturing the electronic component 10a, and hence the description of the other steps is provided above.

It is to be noted that, while the electronic components 10a to 10d are each manufactured by a sequential press-bonding process, the electronic component may be manufactured by a printing process as another example.

Further, while the first to third exemplary modifications of the present invention illustrate examples in which the non-magnetic layer is formed in one or more portions of the first insulator layer 19c, the non-magnetic layer may be formed in the first insulator layer 19a, 19b, 19d, 19e or 19f other than the first insulator layer 19c by using similar means to those described above. Moreover, the electronic component may be manufactured in combination of the first to third modifications such that the non-magnetic layers are formed in plural of the first insulator layers 19a to 19f.

With the electronic component according to the present disclosure, the occurrence of magnetic saturation due to magnetic fluxes circling around the individual coil conductors can be suppressed, and a fall of an inductance value during supply of a current can be reduced.

Further, with the manufacturing method for the electronic component according to the present disclosure, a non-magnetic layer sandwiched between the coil conductors from both sides in the lamination direction can be formed with high accuracy.

Embodiments consistent with the present disclosure are usefully applied to an electronic component and a manufacturing method for the electronic component. In particular, embodiments consistent with the present disclosure are superior in an ability of suppressing the occurrence of the magnetic saturation due to the magnetic fluxes circling around the individual coil conductors.

That which is claimed is:

1. A manufacturing method for an electronic component, comprising a step of forming a laminate that incorporates a helical coil made up of a plurality of coil conductors, and a step of firing the laminate,
wherein the step of forming the laminate comprises:
a step of forming a plurality of first unit layers through a process of preparing a first insulator layer having a first nickel content rate, a process of forming the coil conductors, which constitutes the helical coil, on the first insulator layers, and a process of forming a second insulator layer on a portion of the first insulator layer other than the coil conductors, the second insulator layer having a first bismuth content rate and a second nickel content rate higher than the first nickel content rate; and
a step of laminating the first unit layers.

2. The manufacturing method for the electronic component according to claim 1, wherein the step of forming the laminate further comprises:
a step of forming a second unit layer through a process of preparing another first insulator layer having the first nickel content rate, a process of forming another coil conductor, which constitutes the helical coil, on the another first insulator layer, and a process of forming a third insulator layer on a portion of the another first insulator layer other than the coil conductor, the third insulator layer having a second bismuth content rate lower than the first bismuth content rate and a third nickel content rate higher than the first nickel content rate; and
a step of laminating the first unit layer and the second unit layer.

3. The manufacturing method for the electronic component according to claim 1, wherein the step of forming the laminate further comprises:
a step of forming a third unit layer through a process of preparing another first insulator layer having a first nickel content rate, a process of forming another coil conductor, which constitutes the helical coil, on the another first insulator layer, and a process of forming another second insulator layer and a third insulator layer on portions of the first insulator layer other than the coil conductor, the third insulator layer having a second bismuth content rate lower than the first bismuth content rate and a third nickel content rate higher than the first nickel content rate; and
a step of laminating the first unit layer and the third unit layer.

4. The manufacturing method for the electronic component according to claim 1, wherein a thickness of each of the first insulator layers is smaller than a thickness of each of the second insulator layer.

5. The manufacturing method for the electronic component according to claim 2, wherein a thickness of each of the first insulator layers is smaller than a thickness of each of the second insulator layer.

6. The manufacturing method for the electronic component according to claim 3, wherein a thickness of each of the first insulator layers is smaller than a thickness of each of the second insulator layer.

7. The manufacturing method for the electronic component according to claim 2, wherein a thickness of each first insulator layer is smaller than a thickness of each of the second insulator layer and the third insulator layer.

8. The manufacturing method for the electronic component according to claim 3, wherein a thickness of each first insulator layer is smaller than a thickness of each of the second insulator layer and the third insulator layer.

9. The manufacturing method for the electronic component according to claim 4, wherein the thickness of each first insulator layer is in the range of 5 μm to 35 μm.

10. The manufacturing method for the electronic component according to claim 5, wherein the thickness of each first insulator layer is in the range of 5 μm to 35 μm.

11. The manufacturing method for the electronic component according to claim 6, wherein the thickness of each first insulator layer is in the range of 5 μm to 35 μm.

12. The manufacturing method for the electronic component according to claim 1, wherein the first insulator layer is a non-magnetic layer having a nickel content rate of zero.

13. The manufacturing method for the electronic component according to claim 1, wherein, given that a portion of the first insulator layer, the portion being sandwiched between the coil conductors from both sides facing in a lamination direction, is a first portion, and a portion of the first insulator layer, the portion being sandwiched between the second insulator layers from both sides facing in the lamination direction, is a second portion,
after the step of firing the laminate,
a Ni content rate in the first portion is lower than a Ni content rate in the second portion, and the Ni content rate in the second portion is lower than the Ni content rate in the second insulator layer.

14. The manufacturing method for the electronic component according to claim 1, wherein, given that a portion of the first insulator layer, the portion being sandwiched between the third insulator layers from both sides facing in a lamination direction, is a third portion,
after the step of firing the laminate, a nickel content rate in the third portion is lower than the nickel content rate in the second portion and is lower than the nickel content rate in the third insulator layer.

15. An electronic component including a plurality of first unit layers, each comprising a first insulator layer in form of a sheet, a coil conductor formed on the first insulator layer, and a second insulator layer formed on a portion of the first insulator layer other than the coil conductor,
wherein a helical coil is constituted with the first unit layer laminated in plural and with the coil conductor connected in plural to each other, and
wherein, given that a portion of the first insulator layer, the portion being sandwiched between the coil conductors from both sides facing in a lamination direction, is a first portion, and a portion of the first insulator layer, the portion being sandwiched between the second insulator layers from both sides facing in the lamination direction, is a second portion,
a nickel content rate in the first portion is lower than a nickel content rate in the second portion, and the nickel content rate in the second portion is lower than a nickel content rate in the second insulator layer.

16. The electronic component according to claim 15, wherein the electronic component further includes a second unit layer comprising another first insulator layer in form of a sheet, a coil conductor formed on the first insulator layer, and a third insulator layer formed on a portion of the another first insulator layer other than the coil conductor,
wherein a helical coil is constituted with the first unit layer and the second unit layer laminated and with the coil conductor connected in plural to each other, and
wherein, given that a portion of the first insulator layer, the portion being sandwiched between the third insulator layers from both sides in the lamination direction, is a third portion,
a nickel content rate in the third portion is lower than the nickel content rate in the second portion and is lower than a nickel content rate in the third insulator layer.

17. The electronic component according to claim 15, wherein the electronic component further includes a third unit layer comprising another first insulator layer in form of a sheet, a coil conductor formed on the another first insulator layer, and another second insulator layer and a third insulator layer which are formed on portions of the first insulator layer other than the coil conductor,
wherein a helical coil is constituted with the first unit layer and the third unit layer laminated and with the coil conductor connected in plural to each other, and
wherein, given that a portion of the first insulator layer, the portion being sandwiched between the third insulator layers from both sides in the lamination direction, is a third portion,
a nickel content rate in the third portion is lower than the nickel content rate in the second portion and is lower than a nickel content rate in the third insulator layer.
